(19) United States
(12) Patent Application Publication
(10) Pub. No.: US 2011/0039754 A1
(43) Pub. Date: Feb. 17, 2011

(54) Aqueous Highly Acidic Hard Surface Cleaning Compositions

(75) Inventors: Mattia DeDominicis, Johannesburg (ZA); Dawn Walsh, Montvale, NJ (US)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: RECKITT BENCKISER INC., Parsippany, NJ (US)

(21) Appl. No.: 12/282,276

(22) PCT Filed: Mar. 1, 2007
(86) PCT No.: PCT/GB2006/000175

§ 371 Date: Oct. 19, 2009

Related U.S. Application Data
(60) Provisional application No. 60/781,173, filed on Mar. 10, 2006.

(51) Int. Cl. C11D 3/34

(52) U.S. Cl. 510/362

(57) ABSTRACT

Provided are highly aqueous liquid acidic hard surface cleaning composition having a pH of about 3 or less which comprise: an acid constituent, preferably comprising sulfamic acid and preferably at least one or more further co-acids, and preferably wherein the acid constituent comprises both sulfamic acid and formic acid; at least one nonionic surfactant based on monobranched alkoxylated C10/C11-fatty alcohols; an organic solvent constituent which comprises at least one glycol ether solvent, preferably a glycol ether solvent which desirably mitigates or masks malodors of the acid constituent, especially when the acid constituent comprises formic acid; optionally a cosurfactant constituent, including one or more nonionic, cationic, amphoteric or zwitterionic surfactants; optionally one or more further constituents selected coloring agents, fragrances and fragrance solubilizers, viscosity modifying agents including one or more thickeners, pH adjusting agents and pH buffers including organic and inorganic salts, optical brighteners, opacifying agents, hydrotropes, abrasives, and preservatives, as well as other optional constituents known to the art; and the balance, water, wherein water comprises at least 80% wt. of the composition.

The present invention relates to aqueous acidic hard surface cleaning compositions.

Hard surface cleaning compositions are commercially important products and enjoy a wide field of use, and are known in assisting in the removal of dirt and grime from surfaces, especially those characterized as useful for cleaning “hard surfaces”. Hard surfaces include those which are frequently encountered in lavatories, for example lavatory fixtures such as toilets, shower stalls, bathtubs, bidets, sinks, etc., as well as countertops, walls, floors, etc. In such lavatory environments two types of commonly encountered stains in lavatories include “hard water” stains and “soap scum” stains. Such hard surfaces, and such stains, may also be found in different environments as well, including kitchens, hospitals, etc. Hard water stains are mineral stains caused by the deposition of salts, such as calcium or magnesium salts which are frequently present in hard water which is commonly encountered. Soap, scum stains are residues of fatty acid soaps, such as soaps which are based on alkaline salts of low fatty acids. These fatty acids are known to precipitate in hard water due to the presence of metal salts therein leaving an undesirable residue upon such surfaces. Still further stains, typically referred to as greasy stains, are surface residues which generally comprise hydrophobic materials often with further materials which leave unsightly residues on surfaces.

While the prior art provides a variety of compositions which provide effective cleaning of one or more, typically all of the foregoing classes of stains, there is still an urgent need in the art to provide improved hard surface cleaning compositions which are effective in the treatment of many types of stains typically encountered on hard surfaces, particularly in a home or commercial environment, especially in or around kitchens, bathrooms where cleanliness is of especial importance. It is to such needs that the compositions of the present invention are particularly directed.

Broadly, the present invention relates to liquid acidic hard surface cleaning compositions which are effective against common stains encountered on hard surfaces.

In one specific aspect there is provided a highly aqueous liquid acidic hard surface cleaning composition having a pH of about 3 or less which necessarily comprises:

an acid constituent, preferably comprising sulfamic acid and preferably at least one or more further co-acids, and preferably wherein the acid constituent comprises both sulfamic acid and formic acid;

at least one nonionic surfactant based on monobranched alkoxylated C10/C11-fatty alcohols;

an organic solvent constituent which comprises at least one glycol ether solvent, preferably a glycol ether solvent which mitigates or masks malodors of the acid constituent, especially when the acid constituent comprises formic acid;

optionally a cosurfactant constituent, including one or more nonionic, cationic, amphoteric or zwitterionic surfactants;

optionally one or more further constituents selected coloring agents, fragrances and fragrance solubilizers, viscosity modifying agents including one or more thickeners, pH adjusting agents and pH buffers including organic and inorganic salts, optical brighteners, opacifying agents, hydrotropes, abrasives, and preservatives, as well as other optional constituents known to the art;

and the balance, water, wherein water comprises at least 80% wt. of the composition.

In certain preferred embodiments the nonionic surfactant based on monobranched alkoxylated C10/C11-fatty alcohols is the sole surfactant constituent present in the compositions, to the exclusion of further nonionic, cationic, amphoteric or zwitterionic surfactants.

In a still further preferred embodiment, the nonionic surfactant based on monobranched alkoxylated C10/C11-fatty alcohols is present with one or more nonionic cosurfactants, preferably to the exclusion of further surfactants particularly cationic, amphoteric or zwitterionic surfactants.

In yet further preferred embodiments the compositions include propylene glycol n-propyl ether but excludes other organic solvents.

In further preferred embodiments there are provided carrier substrates, e.g., wipes, sponges, and the like comprising a highly aqueous liquid acidic hard surface cleaning composition as described herein.

The present invention also provides for methods for the treatment of stained hard surfaces in need of cleaning which comprises the step of applying a cleaning effective amount of the acidic hard surface cleaning composition as described herein to a hard surface in need of a cleaning treatment.

The present invention also provides for compositions which exhibit good cleaning properties against dirt and stains commonly found in household, commercial and residential settings, particularly in lavatory settings wherein soap scum stains are frequently encountered.

In a further aspect, the invention provides for acidic hard surface cleaning and/or disinfecting or sanitizing compositions which includes one or more specific glycol ether solvents which inhibit the trigeminal response of a human subject exposed to the said composition especially when the said composition is aerosolized or otherwise sprayed.

It is contemplated that due to the highly acidic pH of the inventive compositions, in addition to good cleaning of a variety of stains commonly encountered on hard surfaces, the inventive compositions may also provide a disinfecting or sanitizing benefit of hard surfaces wherein the presence of undesired microorganisms are suspected such as gram positive or gram negative bacteria.

These and further aspects of the invention including especially preferred aspects will become more apparent from the instant specification.

The compositions of the invention necessarily comprise an acid constituent, preferably the acid constituent comprises sulfamic acid without further acids but preferably comprises at least one or more further co-acids. The acids may be one or more water soluble inorganic acids, mineral acids, or water soluble organic acids, with virtually all such known materials contemplated as being useful in the present inventive compositions. Exemplary inorganic acids for use in the present invention include phosphoric acid, potassium dihydrogenphosphate, sodium dihydrogenphosphate, sodium sulfite, potassium sulfite, sodium pyrosulfite (sodium metabisulfite), potassium pyrosulfite (potassium metabisulfite), acid sodium hexametaphosphate, acid potassium hexametaphosphate, acid sodium pyrophosphate, acid potassium pyrophosphate and sulfamic acid. Alkyl sulfonic acids, e.g., methane sulfonic acid may also be used as a component of the acid system. Strong inorganic acids such as hydrochloric acid, nitric acid and sulfuric acid may also be used, however are less preferred due to their strong acid character; if present are present in only minor amounts in the acid system. The use of water soluble acids are preferred, including water soluble salts of organic acids. Exemplary organic acids are those which generally include at least one carbon atom, and include at least one carboxyl group (—COOH) in its structure. Exemplary useful water soluble organic acids which contain from 1 to about 6 carbon atoms, and at least one carboxyl group as noted. Exemplary useful organic acids include: Exemplary organic acids which may be used include linear aliphatic acids such as acetic acid, citric acid, propionic acid, butyric acid and valeric acid; dicarboxylic acids such as oxalic acid, malonic acid, succinic acid, glutaric acid, adipic acid, pimelic acid, fumaric acid and maleic acid; acidic amino acids such as glutamic acid and aspartic acid; and hydroxy acids such as glycolic acid, lactic acid, hydroxyacrylic acid, α-hydroxybutyric acid, glyceric acid, tartronic acid, malic acid, tartaric acid and citric acid, as well as acid salts of these organic acids. The use of water soluble acids are preferred, including water soluble salts of organic acids.

In certain particularly preferred embodiments the acid constituent comprises both sulfamic acid and formic acid to the exclusion of other organic acids. In still further particularly preferred embodiments the acid constituent comprises both sulfamic acid and formic acid and further includes at least one further co-acid, especially citric acid.

The inventive compositions are necessarily acidic in nature and exhibit a pH of not more than 3. Preferably the pH of the inventive compositions is between 0.001-2.5, more preferably is between 0.1-2, yet more preferably is between 0.1 and 1.5, and especially preferably is between 0.25 and 1. Certain particularly preferable pHs are demonstrated with reference to one or more of the Examples described hereinafter.

The acid constituent may be present in any effective amount, but desirably is not present in amounts of more than about 20% wt. based on the total weight of the compositions. It is to be understood that the nature of the acid or acids selected to form the acid constituent will influence the amount of acid required to obtain a desired final pH or pH range, and the precise amount of acid required for a specific composition can be readily obtained by a skilled artisan utilizing conventional techniques. Further, the amount of acid present in the composition, keeping in mind any optional ingredients that may be present, should be in an amount such that the pH of the composition is about 5 or less, and especially within the preferred pH ranges indicated previously. Generally however, the inclusion of the acid constituent in an amount of from about 1 to 15% wt., more preferably from about 3 to10% wt. has yielded good results. Particularly preferred acids for use in the acid constituent and particularly preferred amounts thereof are described with reference to one or more of the Examples.

The inventor have surprisingly found that compositions including sulfamic acid, as well as compositions including both sulfamic acid and formic acid are particularly effective in the removal of soap scum stains, however the presence of these acids, especially formic acid, imparts a noxious odor to the compositions which discourages their use in consumer products and compositions. However, the inventors have further surprisingly discovered that per careful selection of organic solvents, particularly by careful selection of one or more glycol ethers of the group: phenyl containing glycol ether solvents especially propylene glycol phenyl ether, propylene glycol n-propyl ether and dipropylene glycol n-butyl ether, the noxious odor of the acid constituent, particularly wherein formic acid is present in the acid constituent, can be mitigated. Further, the inclusion of one or more glycol ethers of the aforesaid group has been observed to aid in the soap scum cleaning performance of the compositions within which they are present. Thus, the compositions of the invention necessarily include an organic solvent constituent which comprises at least one glycol ether solvent, preferably a glycol ether solvent which mitigates or masks malodors of the acid constituent, especially when the acid constituent comprises formic acid. Thus the inventive compositions necessarily includes one or more glycol ethers of the group: phenyl containing glycol ether solvents especially propylene glycol phenyl ether, propylene glycol n-propyl ether and dipropylene glycol n-butyl ether which may advantageously be present in an amount effective to mitigate the odor of the acid constituent. In certain particularly preferred embodiments, propylene glycol n-propyl ether is the sole solvent constituent present, and especially particularly is the sole organic solvent present in the inventive compositions. In other preferred embodiments the organic solvent constituent necessarily comprises phenyl containing glycol ether solvents especially propylene glycol phenyl ether, optionally with one or both of propylene glycol n-propyl ether and dipropylene glycol n-butyl ether.

Exemplary useful phenyl containing glycol ether solvents include those which may be represented by the following general structural representation (I):

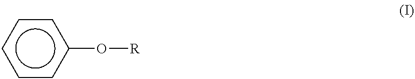

wherein R is a C₁-C₆ alkyl group which contains at least one —OH moiety, and preferably R is selected from: CH₂OH, CH₂CH₂OH, CH(OH)CH₃, CH(OH)CH₂OH, CH₂CH₂CH₂OH, CH₂CH(OH)CH₃, CH(OH)CH₂CH₃, CH(OH)CH₂CH₂OH, CH(OH)CH(OH)CH₃, and CH(OH)CH(OH)CH₂OH, and the phenyl ring may optionally substituted with one or more further moieties such as C₁-C₃ alkyl groups but is preferably unsubstituted.

A particularly useful phenyl containing glycol ether solvent is commercially supplied as DOWANOL PPH, described to be a propylene glycol phenyl ether which is described by it supplier as being represented by the following structural representation (II):

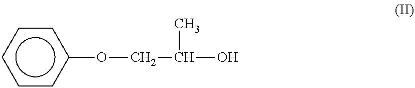

and further, indicated is that the major isomer is as indicated, which suggests that other alkyl isomers are also present.

The organic solvent constituent may be present in noxious odor mitigating effective amounts. Advantageously the organic solvent constituent is present in amount of up to about 10% wt, preferably are present in amounts of from about 0.01-5% wt.

It has surprisingly been observed by the inventors that the inclusion of one or more of one or more glycol ethers of the group: phenyl containing glycol ether solvents especially propylene glycol phenyl ether, propylene glycol n-propyl ether and dipropylene glycol n-butyl ether in the acidic compositions described here, especially particularly when propylene glycol n-propyl ether is present, or is the sole organic solvent present in the compositions, mitigates the noxious odor of the acid constituent. This is particularly true when the acid constituent comprises formic acid. While not wishing to be bound by the following, it is believed that the effect of the foregoing selected glycol ethers, particularly propylene glycol n-propyl ether, acts to diminish or block the trigeminal response of a human subject, viz., a consumer, utilizing the inventive compositions. The trigeminal response of a human subject is a response which is related to but differentiable from a pure olfactory response, and the former is often primarly responsible for sensations of burning, and/or pain when exposed to volatile materials, e.g. volatile organic solvents, perfumes, as well as other chemical compositions and compounds. The inventors have discovered that a meaningful diminishment of the trigeminal response was achieved, particularly in compositions of the invention which comprised both propylene glycol n-propyl ether and formic acid, and especially when the compositions are aerosolized or sprayed from a container. It is therefore believed that these specific group of glycol ethers, especially propylene glycol n-propyl ether, may thus also be included in other hard surface cleaning and/or disinfecting compositions in amounts effective to diminish or block the trigeminal response of a human subject to one or more acids present in the composition. Such an effect may be ascertained by comparison to like compositions which however incorporate a glycol ether or other organic solvent exclusive of glycol ethers of the group: phenyl containing glycol ether solvents especially propylene glycol phenyl ether, propylene glycol n-propyl ether and dipropylene glycol n-butyl ether.

In addition to the essential organic solvent constituent, the inventive compositions may optionally include one or more further organic solvents as a co-solvent constituent. Exemplary useful organic solvents which may be present in the inventive compositions as co-solvents include those which are at least partially water-miscible such as alcohols (e.g., low molecular weight alcohols, such as, for example, ethanol, propanol, isopropanol, and the like), glycols (such as, for example, ethylene glycol, propylene glycol, hexylene glycol, and the like), water-miscible ethers (e.g. diethylene glycol diethylether, diethylene glycol dimethylether, propylene glycol dimethylether), water-miscible glycol ether (e.g. propylene glycol monomethylether, propylene glycol mono ethylether, propylene glycol monopropylether, propylene glycol monobutylether, ethylene glycol monobutylether, dipropylene glycol monomethylether, diethyleneglycol monobutylether), lower esters of monoalkylethers of ethylene glycol or propylene glycol (e.g. propylene glycol monomethyl ether acetate), and mixtures thereof. Glycol ethers having the general structure Ra—Rb—OH, wherein Ra is an alkoxy of 1 to 20 carbon atoms, or aryloxy of at least 6 carbon atoms, and Rb is an ether condensate of propylene glycol and/or ethylene glycol having from one to ten glycol monomer units. Mixtures of two or more specific organic solvents may be used, or alternately a single organic solvent may be provided as the organic solvent constituent.

When present, such optional organic co-solvent(s) may be present in amounts of up to about 7% wt, preferably are present in amounts of from about 0.01-5% wt. As stated previously however, in certain particularly preferred embodiments, the organic co-solvents are excluded from the inventive compositions.

The compositions of the invention necessarily comprise a nonionic surfactant which are monobranched alkoxylated C10-fatty alcohols and/or C11-fatty alcohols; these are jointly referred to as C10/C11-fatty alcohols. These materials are nonionic surfactants are monobranched and may have various degrees of alkoxylation, and are typically ethoxylated with between about 3 and 14 moles of ethylene oxide, typically 4, 5, 6, 7, 8, 9, 10 or 14 moles ethylene oxide. Such nonionic surfactants are presently commercially available under the Lutensol® (ex. BASF AG) and are available in a variety of grades e.g., Lutensol® XL 40 recited by its supplier to be a C10-Guerbet alcohol which is approximately 4 moles of ethoxylation, Lutensol® XL 50 recited by its supplier to be a C10-Guerbet alcohol which is approximately 5 moles of ethoxylation, Lutensol® XL 60 recited by its supplier to be a C10-Guerbet alcohol which is approximately 6 moles of ethoxylation, Lutensol® XL 70 recited by its supplier to be a C10-Guerbet alcohol which is approximately 7 moles of ethoxylation, Lutensol® XL 40 recited by its supplier to be a C10-Guerbet alcohol which is approximately 4 moles of ethoxylation, Lutensol® XL 79 recited by its supplier to be a C10-Guerbet alcohol which is approximately 7 moles of ethoxylation, Lutensol® XL 80 recited by its supplier to be a C10-Guerbet alcohol which is approximately 8 moles of ethoxylation, Lutensol® XL 89 recited by its supplier to be a C10-Guerbet alcohol which is approximately 8 moles of ethoxylation, Lutensol® XL 90 recited by its supplier to be a C10-Guerbet alcohol which is approximately 9 moles of ethoxylation, Lutensol® XL 99 recited by its supplier to be a C10-Guerbet alcohol which is approximately 9 moles of ethoxylation, Lutensol® XL 100 recited by its supplier to be a C10-Guerbet alcohol which is approximately 10 moles of ethoxylation, Lutensol® XL 140 recited by its supplier to be a C10-Guerbet alcohol which is approximately 14 moles of ethoxylation, all available from BASF AG. Alternately or additionally, nonionic surfactant based on monobranched alkoxylated C10-fatty alcohols marketed under the Lutensol® XP series of surfactants, also ex. BASF AG, may also be used. While the foregoing materials are ethoxylated, it is to be understood that other alkoxylated, e.g., propoxylated, butoxylated, as well as mixed ethoxylated and propoxylated branched nonionic alkyl polyethylene glycol ether may also be used.

It is contemplated by the inventors that similar nonionic surfactants based on monobranched alkoxylated C11-fatty alcohols may be used to substitute part of, or all of the nonionic surfactant based on monobranched alkoxylated C10-fatty alcohols. These include for example, the Genapol® UD series described as tradenames Genapol® UD 030, C₁₁-oxo-alcohol polyglycol ether with 3 EO; Genapol® UD, 050 C₁₁-oxo-alcohol polyglycol ether with 5 EO; Genapol® UD 070, C₁₁-oxo-alcohol polyglycol ether with 7 EO; Genapol® UD 080, C₁₁-oxo-alcohol polyglycol ether with 8 EO; Genapol® UD 088, C₁₁-oxo-alcohol polyglycol ether with 8 EO; and Genapol® UD 110, C₁₁-oxo-alcohol polyglycol ether with 11 EO (ex. Clariant).

The nonionic surfactant based on monobranched alkoxylated C10/C11-fatty alcohols (and/or C₁₁-fatty alcohols) is necessarily present in the hard surface cleaning compositions in amount of from 0.01-5% wt., preferably in amount of from 1-3% wt., yet more preferably from 1-2.5% wt. based on the total weight of the hard surface cleaning composition of which it forms a part.

The hard surface cleaning compositions of the invention optionally but in some cases desirably comprise at least one co-surfacant constituent. Such a co-surfactant may be one or more surfactants selected from one or more further anionic, nonionic, cationic, amphoteric or zwitterionic surfactants;

Exemplary of anionic surfactants which may be present include alcohol sulfates and sulfonates, alcohol phosphates and phosphonates, alkyl ester sulfates, alkyl diphenyl ether sulfonates, alkyl sulfates, alkyl ether sulfates, sulfate esters of an alkylphenoxy polyoxyethylene ethanol, alkyl monoglyceride sulfates, alkyl sulfonates, alkyl ether sulfates, alpha-olefin sulfonates, beta-alkoxy alkane sulfonates, alkyl ether sulfonates, ethoxylated alkyl sulfonates, alkylaryl sulfonates, alkylaryl sulfates, alkyl monoglyceride sulfonates, alkyl carboxylates, alkyl ether carboxylates, alkyl alkoxy carboxylates having 1 to 5 moles of ethylene oxide, alkylpolyglycolethersulfates (containing up to 10 moles of ethylene oxide), sulfosuccinates, octoxynol or nonoxynol phosphates, taurates, fatty taurides, fatty acid amide polyoxyethylene sulfates, acyl glycerol sulfonates, fatty oleyl glycerol sulfates, alkyl phenol ethylene oxide ether sulfates, paraffin sulfonates, alkyl phosphates, isethionates, N-acyl taurates, alkyl succinamates and sulfosuccinates, alkylpolysaccharide sulfates, alkylpolyglucoside sulfates, alkyl polyethoxy carboxylates, and sarcosinates or mixtures thereof. These anionic surfactants may be provided as salts with one or more organic counterions, e.g, ammonium, or inorganic counteraions, especially as salts of one or more alkaline earth or alkaline earth metals, e.g, sodium.

Further examples of anionic surfactants include water soluble salts or acids of the formula (ROSO₃)ₓM or (RSO₃)ₓM wherein R is preferably a C₆-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a mono-, di- or tri-valent cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like) and x is an integer, preferably 1 to 3, most preferably 1. Materials sold under the Hostapur and Biosoft trademarks are examples of such anionic surfactants.

Still further examples of anionic surfactants include alkyl-diphenyl-ethersulphonates and alkyl-carboxylates.

Also useful as anionic surfactants are diphenyl disulfonates, and salt forms thereof, such as a sodium salt of diphenyl disulfonate commercially available as Dowfax® 3B2. Such diphenyl disulfonates are included in certain preferred embodiments of the invention in that they provide not only a useful cleaning benefit but concurrently also provide a useful degree of hydrotropic functionality.

Other anionic surfactants can include salts (including, for example, sodium, potassium, ammonium, and substituted ammonium salts such as mono-, di-and triethanolamine salts) of soap, C₆-C₂₀ linear alkylbenzenesulfonates, C₆-C₂₂ primary or secondary alkanesulfonates, C₆-C₂₄ olefinsulfonates, sulfonated polycarboxylic acids prepared by sulfonation of the pyrolyzed product of alkaline earth metal citrates, C₆-C₂₄ alkylpolyglycolethersulfates, alkyl ester sulfates such as C₁₄₋₁₆ methyl ester sulfates; acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), acyl sarcosinates, sulfates of alkylpolysaccharides such as the sulfates of alkylpolyglucoside, branched primary alkyl sulfates, alkyl polyethoxy carboxylates such as those of the formula RO(CH₂CH₂O)ₖCH₂COO⁻M⁺ wherein R is a C₈-C₂₂ alkyl, k is an integer from 0 to 10, and M is a soluble salt-forming cation. Examples of the foregoing anionic surfactants are available under the following tradenames: Rhodapon®, Stepanol®, Hostapur®, Surfine®, Sandopan®, Neodox®, Biosoft®, and Avanel®.

An anionic surfactant compound which may be particularly useful in the inventive compositions when the compositions are at a pH of 2 or less are one or more anionic surfactants based on alphasulphoesters including one or more salts thereof. Such particularly preferred anionic surfactants may be represented by the following general structures:

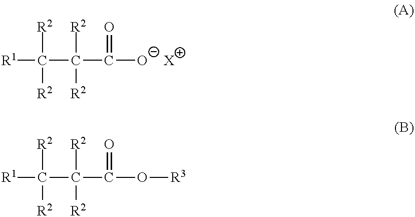

wherein, in each of the foregoing:
R¹ represents a C₆-C₂₂ alkyl or alkenyl group;
each of R² is either hydrogen, or if not hydrogen is a SO₃⁻ having associated with it a cation, X⁺, which renders the compound water soluble or water dispersible, with X preferably being an alkali metal or alkaline earth metal especially sodium or potassium, especially sodium, with the proviso that at least one R², preferably at least two R² is a (SO₃⁻) having an associated cation X⁺, and,
R³ represents a C₁-C₆, preferably C₁-C₄ lower alkyl or alkenyl group, especially methyl.

According to certain preferred embodiments, anionic surfactants are however expressly excluded from the compositions of the present invention.

One class of exemplary useful nonionic surfactants are polyethylene oxide condensates of alkyl phenols. These compounds include the condensation products of alkyl phenols having an alkyl group containing from about 6 to 12 carbon atoms in either a straight chain or branched chain configuration with ethylene oxide, the ethylene oxide being present in an amount equal to 5 to 25 moles of ethylene oxide per mole of alkyl phenol. The alkyl substituent in such compounds can be derived, for example, from polymerized propylene, diisobutylene and the like. Examples of compounds of this type include nonyl phenol condensed with about 9.5 moles of ethylene oxide per mole of nonyl phenol; dodecylphenol condensed with about 12 moles of ethylene oxide per mole of phenol; dinonyl phenol condensed with about 15 moles of ethylene oxide per mole of phenol and diisooctyl phenol condensed with about 15 moles of ethylene oxide per mole of phenol.

Further useful nonionic surfactants include the condensation products of aliphatic alcohols with from about 1 to about 60 moles of ethylene oxide. The alkyl chain of the aliphatic alcohol can either be straight or branched, primary or secondary, and generally contains from about 8 to about 22 carbon atoms. Examples of such ethoxylated alcohols include the condensation product of myristyl alcohol condensed with about 10 moles of ethylene oxide per mole of alcohol and the condensation product of about 9 moles of ethylene oxide with coconut alcohol (a mixture of fatty alcohols with alkyl chains varying in length from about 10 to 14 carbon atoms). Other examples are those C₆-C₁₁ straight-chain alcohols which are ethoxylated with from about 3 to about 6 moles of ethylene oxide. Their derivation is well known in the art. Examples include Alfonic® 810-4.5 (also available as Teric G9A5), which is described in product literature from Sasol as a C₈₋₁₀ having an average molecular weight of 356, an ethylene oxide content of about 4.85 moles (about 60 wt. %), and an HLB of about 12; Alfonic® 810-2, which is described in product literature from Sasol as a C₈₋₁₀ having an average molecular weight of 242, an ethylene oxide content of about 2.1 moles (about 40 wt. %), and an HLB of about 12; and Alfonic® 610-3.5, which is described in product literature from Sasol as having an average molecular weight of 276, an ethylene oxide content of about 3.1 moles (about 50 wt. %), and an HLB of 10. Product literature from Sasol also identifies that the numbers in the alcohol ethoxylate name designate the carbon chain length (numbers before the hyphen) and the average moles of ethylene oxide (numbers after the hyphen) in the product.

Further exemplary useful nonionic surfactants include ethoxylated available from Shell Chemical Company which are described as C₉-C₁₁ ethoxylated alcohols and marketed under the Neodol® tradename. The Neodol® 91 series non-ionic surfactants of interest include Neodol 91-2.5, Neodol 91-6, and Neodol 91-8. Neodol 91-2.5 has been described as having about 2.5 ethoxy groups per molecule; Neodol 91-6 has been described as having about 6 ethoxy groups per molecule; and Neodol 91-8 has been described as having about 8 ethoxy groups per molecule. Still further examples of ethoxylated alcohols include the Rhodasurf® DA series non-ionic surfactants available from Rhodia which are described to be branched isodecyl alcohol ethoxylates. Rhodasurf DA-530 has been described as having 4 moles of ethoxylation and an HLB of 10.5; Rhodasurf DA-630 has been described as having 6 moles of ethoxylation with an HLB of 12.5; and Rhodasurf DA-639 is a 90% solution of DA-630.

Further examples of ethoxylated alcohols include those from Tomah Products (Milton, Wis.) under the Tornadol tradename with the formula RO(CH₂CH₂O)ₙH where R is the primary linear alcohol and n is the total number of moles of ethylene oxide. The ethoxylated alcohol series from Tomah include 91-2.5; 91-6; 91-8—where R is linear C9/C10/C11 and n is 2.5, 6, or 8; 1-3; 1-5; 1-7; 1-73B; 1-9;—where R is C11 and n is 3, 5, 7 or 9; 23-1; 23-3; 23-5; 23-6.5—where R is linear C12/C13 and n is 1, 3, 5, or 6.5; 25-3; 25-7; 25-9; 25-12—where R is linear C12/C13 C14/C15 and n is 3, 7, 9, or 12; and 45-7; 45-13—where R is linear C14/C15 and n is 7 or 13.

Other examples of useful nonionic surfactants include those having a formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12. Surfactants of this formula are presently marketed under the Genapol® tradename. available from Clariant, Charlotte, N.C., include the 26-L series of the general formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from 1 to about 12, such as 26-L-1, 26-L-1.6, 26-L-2, 26-L-3, 26-L-5, 26-L-45, 26-L-50, 26-L-60, 26-L-60N, 26L-75, 26-L-80, 26-L-98N, and the 24-L series, derived from synthetic sources and typically contain about 55% C₁₂ and 45% C₁₄ alcohols, such as 24-L-3, 24-L-45, 24-L-50, 24-L-60, 24-L-60N, 24-L-75, 24-L-92, and 24-L-98N. From product literature, the single number following the “L” corresponds to the average degree of ethoxylation (numbers between 1 and 5) and the two digit number following the letter “L” corresponds to the cloud point in ° C. of a 1.0 wt. % solution in water.

A further class of nonionic surfactants which are contemplated to be useful include those based on alkoxy block copolymers, and in particular, compounds based on ethoxy/propoxy block copolymers. Polymeric alkylene oxide block copolymers include nonionic surfactants in which the major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.

One group of such useful nonionic surfactants containing the characteristic alkylene oxide blocks are those which may be generally represented by the formula (A):

HO-(EO)ₓ(PO)_{y}(EO)_{z}—H (A)

where EO represents ethylene oxide,
PO represents propylene oxide,
y equals at least 15,
(EO)_{x+y} equals 20 to 50% of the total weight of said compounds, and, the total molecular weight is preferably in the range of about 2000 to 15,000. These surfactants are available under the PLURONIC tradename from BASF or Emulgen from Kao.

Another group of nonionic surfactants appropriate for use in the new compositions can be represented by the formula (B):

R-(EO,PO)ₐ(EO,PO)_{b}—H (B)

wherein R is an alkyl, aryl or aralkyl group, where the R group contains 1 to 20 carbon atoms, the weight percent of EO is within the range of 0 to 45% in one of the blocks a, b, and within the range of 60 to 100% in the other of the blocks a, b, and the total number of moles of combined EO and PO is in the range of 6 to 125 moles, with 1 to 50 moles in the PO rich block and 5 to 100 moles in the EO rich block.

Further nonionic surfactants which in general are encompassed by Formula B include butoxy derivatives of propylene oxide/ethylene oxide block polymers having molecular weights within the range of about 2000-5000.

Still further useful nonionic surfactants containing polymeric butoxy (BO) groups can be represented by formula (C) as follows:

RO—(BO)ₙ(EO)ₓ—H (C)

wherein R is an alkyl group containing I to 20 carbon atoms,
n is about 5-15 and x is about 5-15.

Also useful as the nonionic block copolymer surfactants, which also include polymeric butoxy groups, are those which may be represented by the following formula (D):

HO-(EO)ₓ(BO)ₙ(EO)_{y}—H (D)

wherein n is about 5-15, preferably about 15,
x is about 5-15, preferably about 15, and
y is about 5-15, preferably about 15.

Still further useful nonionic block copolymer surfactants include ethoxylated derivatives of propoxylated ethylene diamine, which may be represented by the following formula:

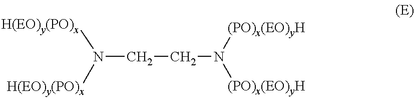

where (EO) represents ethoxy,
(PO) represents propoxy,
   the amount of (PO)ₓ is such as to provide a molecular weight prior to ethoxylation of about 300 to 7500, and the amount of (EO)_{y} is such as to provide about 20% to 90% of the total weight of said compound.

Surfactants based on amine oxides are also contemplated to be useful in the cosurfactant constituent in the present inventive compositions. Exemplary amine oxides include:

alkyl di(C₁-C₇) amine oxides in which the alkyl group has about 10-20, and preferably 12-16 carbon atoms, and can be straight or branched chain, saturated or unsaturated. Examples of such compounds include lauryl dimethyl amine oxide, myristyl dimethyl amine oxide, and those in which the alkyl group is a mixture of different amine oxide, dimethyl cocoamine oxide, dimethyl (hydrogenated tallow) amine oxide, and myristyl/palmityl dimethyl amine oxide;

alkyl di(hydroxy C₁-C₇)amine oxides in which the alkyl group has about 10-20, and preferably 12-16 carbon atoms, and can be straight or branched chain, saturated or unsaturated. Examples of such compounds include bis(2-hydroxyethyl)cocoamine oxide, bis(2-hydroxyethyl)tallowamine oxide; and bis(2-hydroxyethyl)stearylamine oxide;

alkylamidopropyl di(C₁-C₇)amine oxides in which the alkyl group has about 10-20, and preferably 12-16 carbon atoms, and can be straight or branched chain, saturated or unsaturated. Examples of such compounds include cocoamidopropyl dimethyl amine oxide and tallowamidopropyl dimethyl amine oxide; and

alkylmorpholine oxides in which the alkyl group has about 10-20, and preferably 12-16 carbon atoms, and can be straight or branched chain, saturated or unsaturated.

By way of non-limiting example exemplary amphoteric surfactants which are contemplated to be useful in the cosurfactant constituent include one or more water-soluble betaine surfactants which may be represented by the general formula:

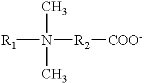

wherein R₁ is an alkyl group containing from 8 to 18 carbon atoms, or the amido radical which may be represented by the following general formula:

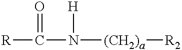

wherein R is an alkyl group having from 8 to 18 carbon atoms, a is an integer having a value of from 1 to 4 inclusive, and R₂ is a C₁-C₄ alkylene group. Examples of such water-soluble betaine surfactants include dodecyl dimethyl betaine, as well as cocoamidopropylbetaine.

A cosurfactant which is desirably present according to certain preferred embodiments of the invention is an alkylpolyglucoside which is to be understood as including alkylmonoglucosides and alkylpolyglucosides surfactant based on a polysaccharide, which are preferably one or more alkyl polyglucosides. These materials may also be referred to as alkyl monoglucosides and alkylpolyglucosides. Suitable alkyl polyglucosides are known nonionic surfactants which are alkaline and electrolyte stable. Such include alkyl glucosides, alkyl polyglucosides and mixtures thereof. Alkyl glucosides and alkyl polyglucosides can be broadly defined as condensation articles of long chain alcohols, e.g., C₈-C₃₀ alcohols, with sugars or starches or sugar or starch polymers i.e., glucosides or polyglucosides. These compounds can be represented by the formula (S)ₙ—O—R wherein S is a sugar moiety such as glucose, fructose, mannose, and galactose; n is an integer of from about 1 to about 1000, and R is a C₈₋₃₀ alkyl group. Examples of long chain alcohols from which the alkyl group can be derived include decyl alcohol, cetyl alcohol, stearyl alcohol, lauryl alcohol, myristyl alcohol, oleyl alcohol and the like.

Alkyl mono- and polyglucosides are prepared generally by reacting a monosaccharide, or a compound hydrolyzable to a monosaccharide with an alcohol such as a fatty alcohol in an acid medium. Various glucoside and polyglucoside compounds including alkoxylated glucosides and processes for making them are disclosed in U.S. Pat. No. 2,974,134; U.S. Pat. No. 3,219,656; U.S. Pat. No. 3,598,865; U.S. Pat. No. 3,640,998; U.S. Pat. No. 3,707,535; U.S. Pat. No. 3,772,269; U.S. Pat. No. 3,839,318; U.S. Pat. No. 3,974,138; U.S. Pat. No. 4,223,129; and U.S. Pat. No. 4,528,106.

Exemplary useful alkyl glucoside surfactants suitable for use in the practice of this invention may be represented by formula I below:

RO—(R₁O)_{y}-(G)ₓZ_{b} I

wherein:
R is a monovalent organic radical containing from about 6 to about 30, preferably from about 8 to about 18 carbon atoms;
R₁ is a divalent hydrocarbon radical containing from about 2 to about 4 carbon atoms;
O is an oxygen atom;
y is a number which has an average value from about 0 to about 1 and is preferably 0;
G is a moiety derived from a reducing saccharide containing 5 or 6 carbon atoms; and
x is a number having an average value from about 1 to 5 (preferably from 1.1 to 2);
Z is O₂M¹,

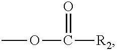

O(CH₂), CO₂M¹, OSO₃M¹, or O(CH₂)SO₃M¹; R₂ is (CH₂)CO₂M¹ or CH═CHCO₂M¹; (with the proviso that Z can be O₂M¹ only if Z is in place of a primary hydroxyl group in which the primary hydroxyl-bearing carbon atom,
—CH₂OH, is oxidized to form a

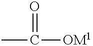

group);
b is a number of from 0 to 3x+1 preferably an average of from 0.5 to 2 per glycosal group;
p is 1 to 10,
M¹ is H⁺ or an organic or inorganic cation, such as, for example, an alkali metal, ammonium, monoethanolamine, or calcium.

As defined in Formula I above, R is generally the residue of a fatty alcohol having from about 8 to 30 and preferably 8 to 18 carbon atoms.

Further exemplary useful alkylpolyglucosides include those according to the formula II:

R₂O—(CₙH₂ₙO)ᵣ—(Z)ₓ II

wherein:

R₂ is a hydrophobic group selected from alkyl groups, alkylphenyl groups, hydroxyalkylphenyl groups as well as mixtures thereof, wherein the alkyl groups may be straight chained or branched, and which contain from about 8 to about 18 carbon atoms,

n has a value of 2-8, especially a value of 2 or 3; r is an integer from 0 to 10, but is preferably 0,

Z is derived from glucose; and,

x is a value from about 1 to 8, preferably from about 1.5 to 5.

Preferably the alkylpolyglucosides are nonionic fatty alkylpolyglucosides which contain a straight chain or branched chain C₈-C₁₅ alkyl group, and have an average of from about 1 to 5 glucose units per fatty alkylpolyglucoside molecule. More preferably, the nonionic fatty alkylpolyglucosides which contain straight chain or branched C₈-C₁₅ alkyl group, and have an average of from about 1 to about 2 glucose units per fatty alkylpolyglucoside molecule.

Examples of such alkylpolyglucosides as described above include, for example, APG™ 325 which is described as being a C₉-C₁₁ alkyl polyglucoside, also commonly referred to as D-glucopyranoside, (ex. Cognis). Further exemplary alkylpolyglucosides include Glucopon® 625 CS which is described as being a C₁₀-C₁₆ alkyl polyglucoside, also commonly referred to as a D-glucopyranoside, (ex. Cognis), lauryl polyglucoside available as APG™ 600 CS and 625 CS (ex. Cognis) as well as other materials sold under the Glucopon® tradename, e.g., Glucopon® 215, Glucopon® 225, Glucopon® 425, especially one or more of the alkylpolyglucosides demonstrated in one or more of the examples. It is believed that the alkylpolyglucoside surfactants sold under the Glucopon® tradename are synthezied at least in part on synthetically produced starting constituents and are colorless or only slightly colored, while those sold under the APG™ are synthesized at least in part on naturally occurring or sourced starting constituents and are more colored in appearance.

When present, any cosurfactant(s) may be present in any cleaning effective amounts up to about 5% wt, preferably are present in amounts of from about 0.01-2.5% wt., yet more preferably from about 0.01-2% wt., based on the total weight of the composition of which it forms a part.

The inventive compositions may optionally include one or more one or more further constituents useful in improving one or more aesthetic characteristics or the compositions or in improving one or more technical characteristics of the compositions. Exemplary further optional constituents include coloring agents, fragrances and fragrance solubilizers, viscosity modifying agents including one or more thickeners, pH adjusting agents and pH buffers including organic and inorganic salts, optical brighteners, opacifying agents, hydrotropes, abrasives, and preservatives, as well as other optional constituents providing improved technical or aesthetic characteristics known to the relevant art. When present, the total amount of such one or more optional constituents present in the inventive compositions do not exceed about 10% wt., preferably do not exceed 2.5% wt., and most preferably do not exceed 1.5% wt.

By way of non-limiting example pH adjusting agents include phosphorus containing compounds, monovalent and polyvalent salts such as of silicates, carbonates, and borates, certain acids and bases, tartrates and certain acetates. Further exemplary pH adjusting agents include mineral acids, basic compositions, and organic acids, which are typically required in only minor amounts. By way of further non-limiting example pH buffering compositions include the alkali metal phosphates, polyphosphates, pyrophosphates, triphosphates, tetraphosphates, silicates, metasilicates, polysilicates, carbonates, hydroxides, and mixtures of the same. Certain salts, such as the alkaline earth phosphates, carbonates, hydroxides, can also function as buffers. It may also be suitable to use as buffers such materials as aluminosilicates (zeolites), borates, aluminates and certain organic materials such as gluconates, succinates, maleates, and their alkali metal salts. When present, the pH adjusting agent, especially the pH buffers are present in an amount effective in order to maintain the pH of the inventive composition within a target pH range.

The inventive compositions may include one or more coloring agents which may be included to impart a desired color or tint to the compositions.

The compositions of the invention optionally but in certain cases desirably include a fragrance constituent. Fragrance raw materials may be divided into three main groups: (1) the essential oils and products isolated from these oils; (2) products of animal origin; and (3) synthetic chemicals.

The essential oils consist of complex mixtures of volatile liquid and solid chemicals found in various parts of plants. Mention may be made of oils found in flowers, e.g., jasmine, rose, mimosa, and orange blossom; flowers and leaves, e.g., lavender and rosemary; leaves and stems, e.g., geranium, patchouli, and petitgrain; barks, e.g., cinnamon; woods, e.g., sandalwood and rosewood; roots, e.g., angelica; rhizomes, e.g., ginger; fruits, e.g., orange, lemon, and bergamot; seeds, e.g., aniseed and nutmeg; and resinous exudations, e.g., myrrh. These essential oils consist of a complex mixture of chemicals, the major portion thereof being terpenes, including hydrocarbons of the formula (C5H8)n and their oxygenated derivatives. Hydrocarbons such as these give rise to a large number of oxygenated derivatives, e.g., alcohols and their esters, aldehydes and ketones. Some of the more important of these are geraniol, citronellol and terpineol, citral and citronellal, and camphor. Other constituents include aliphatic aldehydes and also aromatic compounds including phenols such as eugenol. In some instances, specific compounds may be isolated from the essential oils, usually by distillation in a commercially pure state, for example, geraniol and citronellal from citronella oil; citral from lemon-grass oil; eugenol from clove oil; linalool from rosewood oil; and safrole from sassafras oil. The natural isolates may also be chemically modified as in the case of citronellal to hydroxy citronellal, citral to ionone, eugenol to vanillin, linalool to linalyl acetate, and safrol to heliotropin.

Animal products used in perfumes include musk, ambergris, civet and castoreum, and are generally provided as alcoholic tinctures.

The synthetic chemicals include not only the synthetically made, also naturally occurring isolates mentioned above, but also include their derivatives and compounds unknown in nature, e.g., isoamylsalicylate, amylcinnamic aldehyde, cyclamen aldehyde, heliotropin, ionone, phenylethyl alcohol, terpineol, undecalactone, and gamma nonyl lactone.

Fragrance compositions as received from a supplier may be provided as an aqueous or organically solvated composition, and may include as a hydrotrope or emulsifier a surface-active agent, typically a surfactant, in minor amount. Such fragrance compositions are quite usually proprietary blends of many different specific fragrance compounds. However, one of ordinary skill in the art, by routine experimentation, may easily determine whether such a proprietary fragrance composition is compatible in the compositions of the present invention.

One or more coloring agents may also be used in the inventive compositions in order to impart a desired colored appearance or colored tint to the compositions. Known art water soluble or water dispersible pigments and dyes may be added in effective amounts.

The inventive compositions may include a hydrotrope constituent comprising one or more compounds which exhibit a hydrotropic functionality in the inventive compositions. Exemplary hydrotropes include, inter alfa, benzene sulfonates, naphthalene sulfonates, C₁-C₁₁ alkyl benzene sulfonates, naphthalene sulfonates, C₅-C₁₁ alkyl sulfonates, C₆-C₁₁ alkyl sulfates, alkyl diphenyloxide disulfonates, and phosphate ester hydrotropes. The hydrotropic compounds of the invention are often provided in a salt form with a suitable counterion, such as one or more alkali, or alkali earth metals, such as sodium or potassium, especially sodium. However, other water soluble cations such as ammonium, mono-, di- and tri-lower alkyl, i.e., C₁₋₄ alkanol ammonium groups can be used in the place of the alkali metal cations. Exemplary alkyl benzene sulfonates include, for example, isopropylbenzene sulfonates, xylene sulfonates, toluene sulfonates, cumene sulfonates, as well as mixtures thereof. Exemplary C₅-C₁₁ alkyl sulfonates include hexyl sulfonates, octyl sulfonates, and hexyl/octyl sulfonates, and mixtures thereof. Particularly useful hydrotrope compounds include benzene sulfonates, o-toluene sulfonates, m-toluene sulfonates, and p-toluene sulfonates; 2,3-xylene sulfonates, 2,4-xylene sulfonates, and 4,6-xylene sulfonates; cumene sulfonates, wherein such exemplary hydrotropes are generally in a salt form thereof, including sodium and potassium salt forms. When present the hydrotrope constituent may be present in any effective amounts, or they may be omitted. Advantageously, when present, the hydrotrope constituent comprises 0.001-1% wt. of the composition of which it forms a part.

A further optional constituent are one or more preservatives. Such preservatives are primarily included to reduce the growth of undesired microorganisms within the composition during storage prior to use. Exemplary useful preservatives-include compositions which include parabens, including methyl parabens and ethyl parabens, glutaraldehyde, formaldehyde, 2-bromo-2-nitropropoane-1,3-diol, 5-chloro-2-methyl-4-isothiazolin-3-one, 2-methyl-4-isothiazoline-3-one, and mixtures thereof. One exemplary composition is a combination 5-chloro-2-methyl-4-isothiazolin-3-one and 2-methyl-4-isothiazolin-3-one where the amount of either component may be present in the mixture anywhere from 0.001 to 99.99 weight percent, based on the total amount of the preservative. Further exemplary useful preservatives include those which are commercially including a mixture of 5-chloro-2-methyl-4-isothiazolin-3-one and 2-methyl-4-isothiazolin-3-one marketed under the trademark KATHON® CG/ICP as a preservative composition presently commercially available from Rohm and Haas (Philadelphia, Pa.). Further useful and commercially available preservative compositions include KATHON® CG/ICP II, a further preservative composition presently commercially available from Rohm and Haas (Philadelphia, Pa.), PROXEL® which is presently commercially available from Zeneca Biocides (Wilmington, Del.), SUTTOCIDE® A which is presently commercially available from Sutton Laboratories (Chatam, N.J.) as well as TEXTAMER® 38AD which is presently commercially available from Calgon Corp. (Pittsburgh, Pa).

Optionally one or more abrasives may be included in the inventive compositions. Exemplary abrasives include: oxides, e.g., calcined aluminum oxides and the like, carbonates, e.g., calcium carbonate and the like, quartzes, siliceous chalk, diatomaceous earth, colloidal silicon dioxide, alkali metasilicates, e.g., sodium metasilicate and the like, perlite, pumice, feldspar, calcium phosphate, organic abrasive materials based on comminuted or particulate polymers especially one or more of polyolefins, polyethylenes, polypropylenes, polyesters, polystyrenes, acetonitrile-butadiene-styrene resins, melamines, polycarbonates, phenolic resins, epoxies and polyurethanes, natural materials such as, for example, rice hulls, corn cobs, and the like, or talc and mixtures thereof. The particle size of the abrasive agent typically may range from about 1 μm to about 1000 μm, preferably between about 10 μm to about 200 μm, and more preferably between about 10 μm and about 100 μm. It is preferred to us those abrasive agents that will not scratch most hard surfaces. Such abrasive agents include calcium carbonate, siliceous chalk, diatomaceous earth, colloidal silicon dioxide, sodium metasilicate, talc, and organic abrasive materials. Calcium carbonate is preferred as being effective and available at a generally low cost. A single type of abrasive, or a mixture of two or more differing abrasive materials may be used.

Optionally the compositions may include an effective amount of at least one inorganic chloride salt, which are believed to improve the metal cleaning characteristics of the inventive compositions. The inorganic chloride salt is desirably present in an amount effective to provide improved cleaning of metal surfaces which are immersed or contacted with the inventive compositions. The inorganic chloride salt(s) used in the compositions of the present invention can be any water-soluble inorganic chloride salt or mixtures of such salts. For purposes of the present invention, “water-soluble” means having a solubility in water of at least 10 grams per hundred grams of water at 20° C. Examples of suitable salts include various alkali metal and/or alkaline earth metal chlorides including sodium chloride, calcium chloride, magnesium chloride and zinc chloride. Particularly preferred are sodium chloride and calcium chloride which have been surprisingly observed to provide excellent metal cleaning efficacy particularly of aged copper surfaces. The inorganic chloride salt(s) is present in the compositions of the present invention in an amount which will provide an improved cleaning of metal surfaces, particularly copper surfaces, compared to an identical composition which excludes the inorganic chloride salts(s). Preferably the inorganic chloride salt(s) are present in amounts of from about 0.00001 to about 2.5% by weight, desirably in amounts of 0.001 to about 2% by weight, yet more desirably from about 0.01 to about 1.5% by weight and most desirably from about 0.2 to about 1.5% weight. Particularly preferred inorganic chloride salt(s) and weight percentages thereof are described with reference to one or more of the Examples. In certain preferred embodiments the sole inorganic salts present are one or more inorganic chloride salts.

The inventive compositions may include a thickener constituent which may be added in any effective amount in order to increase the viscosity of the compositions. Exemplary thickeners useful in the thickener constituent include one or more of polysaccharide polymers selected from cellulose, alkyl celluloses, alkoxy celluloses, hydroxy alkyl celluloses, alkyl hydroxy alkyl celluloses, carboxy alkyl celluloses, carboxy alkyl hydroxy alkyl celluloses, naturally occurring polysaccharide polymers such as xanthan gum, guar gum, locust bean gum, tragacanth gum, or derivatives thereof, polycarboxylate polymers, polyacrylamides, clays, and mixtures thereof.

Examples of the cellulose derivatives include methyl cellulose ethyl cellulose, hydroxymethyl cellulose hydroxy ethyl cellulose, hydroxy propyl cellulose, carboxy methyl cellulose, carboxy methyl hydroxyethyl cellulose, hydroxypropyl cellulose, hydroxy propyl methyl cellulose, ethylhydroxymethyl cellulose and ethyl hydroxy ethyl cellulose.

Exemplary polycarboxylate polymers thickeners have a molecular weight from about 500,000 to about 4,000,000, preferably from about 1,000,000 to about 4,000,000, with, preferably, from about 0.5% to about 4% crosslinking. Preferred polycarboxylate polymers include polyacrylate polymers including those sold under trade names Carbopol®, Acrysol® ICS-1 and Sokalan®. The preferred polymers are polyacrylates. Other monomers besides acrylic acid can be used to form these polymers including such monomers as ethylene and propylene which act as diluents, and maleic anhydride which acts as a source of additional carboxylic groups.

Exemplary clay thickeners comprise, for example, colloid-forming clays, for example, such as smectite and attapulgite types of clay thickeners. The clay materials can be described as expandable layered clays, i.e., aluminosilicates and magnesium silicates. The term “expandable” as used to describe the instant clays relates to the ability of the layered clay structure to be swollen, or expanded, on contact with water. The expandable clays used herein are those materials classified geologically as smectites (or montmorillonite) and attapulgites (or polygorskites).

Preferred thickeners are those which provide a useful viscosity increasing benefit at the ultimate pH of the compositions, particularly thickeners which are useful at pH's of about 3 or less. While in certain embodiments the compositions may comprise a thicker constituent, it is generally preferred the compositions exhibit viscosities similar to that of water. The compositions preferably have a viscosity of not more than about 50 cps at room temperature, more preferably have a viscosity of not more than about 30 cps at room temperature.

As is noted above, the compositions according to the invention are largely aqueous in nature. Water is added to order to provide to 100% by weight of the compositions of the invention. The water may be tap water, but is preferably distilled and is most preferably deionized water. If the water is tap water, it is preferably substantially free of any undesirable impurities such as organics or inorganics, especially minerals salts which are present in hard water which may thus undesirably interfere with the operation of the constituents present in the aqueous compositions according to the invention. Preferably at least 80% wt, more preferably at least 85% wt of the compositions are water.

According to certain specific preferred embodiments there is provided a highly aqueous liquid acidic hard surface cleaning composition having a pH of about 2 or less, preferably having pH of about 0.2-1 which necessarily comprises:

1-15% wt. of an acid constituent comprising sulfamic acid, but preferably necessarily comprising both sulfamic acid and formic acid, and optionally further comprising citric acid but excluding other inorganic or organic acids;

0.01-10% wt. of an organic solvent constituent which comprises at least one glycol ether solvent selected from the group: phenyl containing glycol ether solvents especially propylene glycol phenyl ether, propylene glycol n-propyl ether and dipropylene glycol n-butyl ether, but is preferably solely propylene glycol n-propyl ether or is solely propylene glycol n-propyl ether with at least one phenyl containing glycol ether solvents especially propylene glycol phenyl ether, and further, wherein the organic solvent constituent excludes co-solvents;

0.01-5% wt. of at least one nonionic surfactant based on monobranched alkoxylated C10/C11-fatty alcohols;

optionally 0.01-5% wt. of a cosurfactant constituent, including one or more nonionic, cationic, amphoteric or zwitterionic surfactants and most desirably wherein the cosurfactant constituent consists solely of one or more nonionic surfactants;

optionally 0.01-5% wt. of one or more further constituents selected coloring agents, fragrances and fragrance solubilizers, viscosity modifying agents including one or more thickeners, pH adjusting agents and pH buffers including organic and inorganic salts, optical brighteners, opacifying agents, hydrotropes, abrasives, and preservatives, as well as other optional constituents known to the art;

and the balance, water, wherein water comprises at least 80% wt. of the composition.

The compositions according to the invention are desirably provided as a ready to use product which may be directly applied to a hard surface. Hard surfaces which are to be particularly denoted are lavatory fixtures, lavatory appliances (toilets, bidets, shower stalls, bathtubs and bathing appliances), wall and flooring surfaces especially those which include refractory materials and the like. Further hard surfaces which are particularly denoted are those associated with dishwashers, kitchen environments and other environments associated with food preparation. Hard surfaces which are those associated with hospital environments, medical laboratories and medical treatment environments. Such hard surfaces described above are to be understood as being recited by way of illustration and not be way of limitation.

The inventive compositions may be packaged in any suitable container particularly flasks or bottles, including squeeze-type bottles, as well as bottles provided with a spray apparatus which is used to dispense the composition by spraying. The inventive compositions are readily pourable and readily pumpable cleaning compositions which features the benefits described above. Accordingly the inventive compositions are desirably provided as a ready to use product in a manually operated spray dispensing container, or may be supplied in aerosolized product wherein it is discharged from a pressurized aerosol container. Propellants which may be used are well known and conventional in the art and include, for example, a hydrocarbon, of from 1 to 10 carbon atoms, such as n-propane, n-butane, isobutane, n-pentane, isopentane, and mixtures thereof; dimethyl ether and blends thereof as well as individual or mixtures of chloro-, chlorofluoro- and/or fluorohydrocarbons- and/or hydrochlorofluorocarbons (HCFCs). Useful commercially available compositions include A-70 (Aerosol compositions with a vapor pressure of 70 psig available from companies such as Diversified and Aeropress) and Dymel® 152a (1,1-difluoroethane from DuPont). Compressed gases such as carbon dioxide, compressed air, nitrogen, and possibly dense or supercritical fluids may also be used. In such an application, the composition is dispensed by activating the release nozzle of said aerosol type container onto the area in need of treatment, and in accordance with a manner as above-described the area is treated (e.g., cleaned and/or sanitized and/or disinfected). If a propellant is used, it will generally be in an amount of from about 1% to about 50% of the aerosol formulation with preferred amounts being from about 2% to about 25%, more preferably from about 5% to about 15%. Generally speaking, the amount of a particular propellant employed should provide an internal pressure of from about 20 to about 150 psig at 70° F.

The compositions according to the invention can also be suited for use in a consumer “spray and wipe” application as a cleaning composition. In such an application, the consumer generally applies an effective amount of the composition using the pump and within a few moments thereafter, wipes off the treated area with a rag, towel, or sponge, usually a disposable paper towel or sponge. In certain applications, however, especially where undesirable stain deposits are heavy, the cleaning composition according to the invention may be left on the stained area until it has effectively loosened the stain deposits after which it may then be wiped off, rinsed off, or otherwise removed. For particularly heavy deposits of such undesired stains, multiple applications may also be used. Optionally, after the composition has remained on the surface for a period of time, it could be rinsed or wiped from the surface.

It is contemplated that certain preferred embodiments of inventive formulations may also provide a disinfecting or sanitizing benefit to hard surfaces wherein the presence of undesired microorganisms are suspected such as gram positive or gram negative bacteria. This is due to the low pH of particularly preferred embodiments of the invention, particularly wherein the compositions are at a pH of 3 or less, preferably at a pH of 2 or less and most preferably at a pH of about 1.7 or less. Also provided is a method for the treatment of hard surfaces wherein the presence of such undesired microorganisms are suspected which method includes the step of applying a disinfecting or sanitizing effective amount of a composition described herein.

Whereas the compositions of the present invention are intended to be used in the types of liquid forms described, nothing in this specification shall be understood as to limit the use of the composition according to the invention with a further amount of water to form a cleaning solution therefrom. In such a proposed diluted cleaning solution, the greater the proportion of water added to form said cleaning dilution will, the greater may be the reduction of the rate and/or efficacy of the thus formed cleaning solution. Accordingly, longer residence times upon the stain to effect their loosening and/or the usage of greater amounts may be necessitated. Conversely, nothing in the specification shall be also understood to limit the forming of a “super-concentrated” cleaning composition based upon the composition described above. Such a super-concentrated ingredient composition is essentially the same as the cleaning compositions described above except in that they include a lesser amount of water.

The composition of the present invention, whether as described herein or in a concentrate or super concentrate form, can also be applied to a hard surface by the use of a carrier substrate. One example of a useful carrier substrate is a wet wipe. The wipe can be of a woven or non-woven nature. Fabric substrates can include nonwoven or woven pouches, sponges including both closed cell and open celled sponges, including sponges formed from celluloses as well as other polymeric material, as well as in the form of abrasive or non-abrasive cleaning pads. Such fabrics are known commercially in this field and are often referred to as wipes. Such substrates can be resin bonded, hydroentangled, thermally bonded, meltblown, needlepunched, or any combination of the former. The carrier substrate useful'with the present inventive compositions may also be a wipe which includes a film forming substrate such as a water soluble polymer. Such self-supporting film substrates may be sandwiched between layers of fabric substrates and heat sealed to form a useful substrate.

The compositions of the present invention are advantageously absorbed onto the carrier substrate, i.e., a wipe to form a saturated wipe. The wipe can then be sealed individually in a pouch which can then be opened when needed or a multitude of wipes can be placed in a container for use on an as needed basis. The container, when closed, sufficiently sealed to prevent evaporation of any components from the compositions. In use, a wipe is removed from the container and then wiped across an area in need of treatment; in case of difficult to treat stains the wipe may be re-wiped across the area in need of treatment, or a plurality of saturated wipes may also be used.

Certain embodiments of the invention, including certain particularly preferred embodiments of the invention are disclosed in the following examples.

### EXAMPLES

A number of formulations were produced by mixing the constituents outlined in Table 1 by adding the individual constituents into a beaker of deionized water at room temperature which was stirred with a conventional magnetic stirring rod. Stirring continued until the formulation was homogenous in appearance. It is to be noted that the constituents might be added in any order, but it is preferred that a first premixture is made of any fragrance constituent with one or more surfactants used in the inventive compositions. Thereafter, a major amount of water is first provided to a suitable mixing vessel or apparatus as it is the major constituent and thereafter the further constituents are added thereto convenient. The order of addition is not critical, but good results are obtained where the surfactants (which may be also the premixture of the fragrance and surfactants) are added to the water prior to the remaining constituents.

The exact compositions of the example formulations are listed on Table 1, below, and are identified by one or more digits preceded by the letter “E”. Certain comparative compositions are also disclosed on Table 1, and are identified by one or more digits preceded by the letter “C”.

TABLE 1

| | C1 | C2 | C3 | C4 | C5 | C6 | C7 | C8 |
|---|---|---|---|---|---|---|---|---|
| sulfamic acid (99.5%) | 5.0 | 5.0 | 5.0 | 5.0 | 5.0 | 5.0 | 5.0 | 5.0 |
| citric acid (99.5%) | — | 5.0 | — | — | 5.0 | — | 5.0 | — |
| formic acid (94%) | — | — | 4.0 | 4.0 | — | 4.0 | 4.0 | — |
| Neodol 91-6 (99- | 0.5 | 0.5 | 0.5 | 0.5 | 0.5 | 0.5 | 0.5 | 0.5 |
| 100%) | | | | | | | | |
| Lutensol XL 79 (80- | — | — | — | — | — | — | — | — |
| 90%) | | | | | | | | |
| Dowanol PPH (93%) | — | — | — | — | 0.5 | 0.5 | 0.5 | 0.5 |
| Dowanol DPnB (98.5%) | — | 1.0 | 1.0 | — | 1.0 | 1.0 | — | — |
| Dowanol PnP (95%) | — | — | 1.0 | 1.0 | 1.0 | — | — | 1.0 |
| colorant (1% wt.) | 0.05 | 0.05 | 0.05 | 0.05 | 0.05 | 0.05 | 0.05 | 0.05 |
| fragrance | 0.15 | 0.15 | 0.15 | 0.15 | 0.15 | 0.15 | 0.15 | 0.15 |
| deionized water | q.s. | q.s. | q.s. | q.s. | q.s. | q.s. | q.s. | q.s. |
| pH | 0.7 | 0.63 | 0.65 | 0.60 | 0.65 | 0.66 | 0.60 | 0.70 |

| | E1 | E2 | E3 | E4 | E5 | E6 |
|---|---|---|---|---|---|---|
| sulfamic acid (99.5%) | 5.0 | 5.0 | 5.0 | 5.0 | 5.0 | 5.0 |
| citric acid (99.5%) | — | 5.0 | 5.0 | — | 5.0 | — |
| formic acid (94%) | — | — | 4.0 | — | — | 4.0 |
| Neodol 91-6 (99-100%) | 0.5 | 0.5 | 0.5 | 0.5 | 0.5 | 0.5 |
| Lutensol XL 79 (80-90%) | 2.0 | 2.0 | 2.0 | 2.0 | 2.0 | 2.0 |
| Dowanol PPH (93%) | — | — | — | 0.5 | 0.5 | 0.5 |
| Dowanol DPnB (98.5%) | 1.0 | — | 1.0 | 1.0 | — | — |
| Dowanol PnP (95%) | 1.0 | 1.0 | 0.0 | — | — | 1.0 |
| colorant (1% wt.) | 0.05 | 0.05 | 0.05 | 0.05 | 0.05 | 0.05 |
| fragrance | 0.15 | 0.15 | 0.15 | 0.15 | 0.15 | 0.15 |
| deionized water | q.s. | q.s. | q.s. | q.s. | q.s. | q.s. |
| pH | 0.72 | 0.64 | 0.65 | 0.69 | 0.65 | 0.66 |

| | E7 | E8 | E9 | E10 | E11 | E12 | E13 |
|---|---|---|---|---|---|---|---|
| sulfamic acid (99.5%) | 5.0 | 5.0 | 5.0 | 5.0 | 5.0 | 5.0 | 5.0 |
| citric acid (99.5%) | — | — | — | — | — | 5.0 | 2.5 |
| formic acid (94%) | 2.69 * | 4.0 | 4.0 | 3.6 | 2.77 | 4.0 | 2.0 |
| Neodol 91-6 (99-100%) | 0.5 | 0.5 | 0.5 | 0.5 | 0.5 | 0.5 | 0.5 |
| Lutensol XL 79 (80-90%) | 1.3 | 1.82 | 1.58 | 1.31 | 1.28 | 2.0 | 1.0 |
| Dowanol PPH (93%) | — | — | — | — | — | 0.5 | 0.25 |
| Dowanol DPnB (98.5%) | — | 0.5 | — | — | — | 1.0 | 0.5 |
| Dowanol PnP (95%) | 0.3 | 0.3 | 0.3 | 0.3 | 0.3 | 1.0 | 0.5 |
| colorant (1% wt.) | 0.05 | 0.05 | 0.05 | 0.05 | 0.05 | 0.05 | 0.05 |
| fragrance | 0.15 | 0.15 | 0.15 | 0.15 | 0.15 | 0.15 | 0.15 |
| deionized water | q.s. | q.s. | q.s. | q.s. | q.s. | q.s. | q.s. |
| pH | 0.65 | 0.72 | 0.71 | 0.72 | 0.75 | 0.59 | 0.64 |

* denotes formic acid (95%)

All of the formulations on the foregoing Table 1 is indicated in weight percent, and each composition comprised 100% wt. The individual constituents were used, “as-supplied” from their respective source and unless otherwise indicated, each of the constituents are to be understood as being “100% wt. actives”. Deionized water was added in quantum sufficient, “q.s.”, to provide the balance to 100% wt. of each of the example compositions. The sources of the constituents used in the formulations of Tables 1 are described on the following Table 2.

TABLE 2

| | |
|---|---|
| sulfamic acid (99.5%) | anhydrous sulfamic acid, 99.5% wt. actives |
| citric acid (99.5%) | anhydrous citric acid, 99.5% wt. actives |
| formic acid (94%) | aqueous solution, formic acid, 94-95% wt. |
| | actives |
| Neodol 91-6 (99-100%) | C₉₋₁₁ linear alcohol ethoxylate, 6 EO |
| | supplied as NEODOL 91-6 (Ex. Shell), 99- |
| | 100% wt. actives |
| Lutensol XL 79 (80-90%) | C10-Guerbet alcohol ethoxylate, 7 moles |
| | ethoxylation (ex. BASF) (80-90% wt. |
| | actives) |
| Dowanol PPH (93%) | propylene glycol phenyl ether, supplied as |
| | Dowanol PPH (ex. Dow Chem. Co.), 93% |
| | wt. actives |
| Dowanol DPnB (98.5%) | dipropylene glycol n-butyl ether supplied |
| | as Dowanol DPnB (ex. Dow Chem. Co.), |
| | 98.5% wt. actives |
| Dowanol PnP (95%) | Propylene glycol n-propyl ether supplied |
| | as Dowanol PnP (ex. Dow Chem. Co.), |
| | 95% wt. actives |
| fragrance | fragrance composition, proprietary |
| | composition of its supplier |
| colorant | aqueous dispersion of a C.I. Acid due |
| | (1% wt. actives) |
| di water | deionized water |

Several of the foregoing compositions were tested and evaluated according to one or more of the following test protocols.

Each of the foregoing compositions on Table 1 exhibited a pH in the range of 0.5-1; specific pHs of the individual compositions are indicated on Table 1.

### Limescale Removal Evaluation:

The efficacy of an inventive composition to remove limescale was demonstrated by the following test.

Several pre-weighed and dried marble cubes (measured in grams) were placed into 40 gram aliquots of compositions described in more detail on Table 1. After 1 minute, the cubes were removed, rinsed with deionized water, dried for 1 hour under moderate heat, and then allowed to return to room temperature before being weighed. This process was repeated for further example compositions with several marble cubes to establish the mass lost from the marble cubes due to immersion in the test compositions; the results from are indicated on the following table.

For comparative purposes a commercially available preparation, BREF (ex. Henkel KGAA, Germany) was also evaluated using the same test protocol recited above for the compositions according to the invention. The results of the evaluation are reported on the following Table.

TABLE
Limescale Removal

| | % limescale removed |
|---|---|
| C1 | 0.679 |
| C2 | 0.567 |
| C3 | 0.791 |
| C4 | 0.535 |
| C5 | 0.610 |
| C6 | 0.850 |
| C7 | 0.708 |
| C8 | 0.696 |
| — | — |
| “BREF” | 0.381 |
| — | — |
| E1 | 0.556 |
| E2 | 0.521 |
| E3 | 0.497 |
| E4 | 0.490 |
| E5 | 0.503 |
| E6 | 0.648 |
| E7 | |
| E8 | 0.712 |
| E9 | 0.774 |
| E10 | 0.782 |
| E11 | 0.782 |
| E12 | 0.558 |
| E13 | 0.589 |

From the foregoing reported results, the inventive compositions exhibit good limescale removal efficacy and were significantly superior to that of the commercially available “BREF” product tested.

### Soap Scum Cleaning Evaluation:

The efficacy of both compositions according to comparative examples as well as compositions according to the invention in removing soap scum from a hard surface was evaluated in accordance with CSMA Methods DCC-16 (May 1995) titled “Guidelines for Evaluating the Efficacy of Bathroom Cleaners—Part 2: Scrubber Test for Measuring the Removal of Lime Soap”. This test is described generally as follows:

First, a “parent” soil is made, based on the following formulation:

| “Parent” soil | % w/w |
|---|---|
| bar soap | 3.90 |
| shampoo | 0.35 |
| clay | 0.06 |
| artificial sebum | 0.15 |
| hard water | 95.54 |

The parent soil was produced according to the following steps: First, the bar soap was shaved into a suitable beaker. Afterward the remaining constituents were added in the order given above and stirred with three-blade propeller mixer. Next, the contents of the beaker was heated to 45-50° C. and mixed until a smooth, lump-free suspension was achieved. This usually required about two hours with moderate agitation. Subsequently, the contents of the beaker were filtered through a Buchner funnel fitted with Whatman #1 filter paper or equivalent. The filtrate was then resuspended in clean, deionized water, using the same amount of water used to make the soil, and this was filtered again. The (re-filtered) filtrate was uniformly dried overnight at 45° C. to form a filter cake. Thereafter, the filter cake was pulverized and was suitable for immediate use, or may be stored in a sealed container for up to six months.

The test substrates (tiles) were prepared in the following manner: each tile was thoroughly washed (using a commercially available hand dishwashing detergent such as, Dove®) and scrubbed using a non-metallic scouring pad (such as a Chore Boy® Long Last scrubbing sponge). The washed tiles were then permitted to dry in an oven at 40.5° C. overnight, then withdrawn and allowed to cool to room temperature (approx. 20° C.) before being provided with the standardized “hard water” test soil. It is to be noted that for each test, new tiles were utilized, namely, the tiles were not reused. In preparation for supplying the tiles with an amount of the test soil, a test soil was prepared based on the following formulation:

| Test soil: | % w/w |
|---|---|
| “parent” soil | 4.50 |
| hard water | 9.0 |
| hydrochloric acid (0.1 N) | 0.77 |
| acetone | 85.73 |

The test soil was produced according to the following steps: The constituents indicated were introduced into a clean beaker, with the acetone being added prior to the water, and the ‘parent’ soil being added last. The contents of the beaker were mixed using a standard three blade laboratory mixer until the contents formed a uniform mixture, and the color changed from white to gray. This typically required 20-40 minutes, during which time the beaker was covered as much as possible to avoid excessive solvent loss. Next, a suitable quantity of the contents of the test soil from the beaker was provided to an artist's airbrush while the beaker was swirled to ensure soil uniformity. (If testing required more than one day, a fresh amount of test soil was prepared daily and used for that day's testing.)

Soil was applied to a number of clean, dry tiles placed into rows and columns in preparation for depositing of the test soil. The airbrush was operated at 40 psi, and the test soil was sprayed to provide a visually uniform amount of soil onto the tiles. (Uniform soil suspension during application was maintained by continuous brush motion and/or swirling of test soil in the airbrush.) In this manner, approximately 0.10 g-0.15 g test soil were applied per tile.

The tiles were then allowed to air dry for approximately 30-60 minutes, during which time a laboratory hotplate was preheated to approximately 320° C. Each tile was sequentially placed on the hotplate until the test soil began to melt, thereby “aging” the test soil. The melting of the test soil was observed carefully, and each tile was removed shortly before the soil began to coalesce into large droplets. This process was repeated for each tile, allowing the hotplate to recover to 320° C. between tiles. Subsequently each tile was permitted to cool for at least about 30 minutes.

To evaluate cleaning, a treated test tile was placed in a Gardner Apparatus and secured. A dry 10 cm by 7.6 cm sponge was first moistened with 100 g of tap water, and the excess wrung out from the sponge. The sponge was then fitted into a suitably sized holder in the Gardner Apparatus. A 2 gram aliquot of a test formulation was then deposited directly onto the soiled surface of a tile, and allowed to contact the tile for 45 seconds. Thereafter, the Gardner Apparatus was cycled for 6 strokes. The tile was then rinsed with tap water, and dried with compressed air from an airbrush compressor. This test was repeated several times for each formulation, using a new treated test tile for each evaluation.

The tested tiles were evaluated by either reflective means, i.e., using a BYK Tri-Gloss meter at 60 degrees in order to determine the change in reflectance between an unsoiled, untreated tile which was used as a “control”, and the reflectance of a soiled tile which was cleaned using a quantity of an inventive composition in accordance with the test protocol described above. According to the reflective means, the percentage soap scum removal was determined utilizing the following equation:

$$\% Removal = \frac{RC - RS}{RO - RS} \times 100$$

where

RC=Reflectance of tile after cleaning with test product

RO=Reflectance of original soiled tile

RS=Reflectance of soiled tile.

For each tile, a number of readings were taken and the results averaged to provide a median reading for each tile. Six tiles were used to evaluate each of the tested compositions and the average reading for each tile, as well as the averaged reflectance reading for all five tiles treated using a particular composition described in Table 1 are reproduced below. The tested tiles were evaluated, and the results of the calculated “% removal” are indicated on the following table.

TABLE
Soap Scum Cleaning

| | % removed |
|---|---|
| C1 | 7.88 |
| C2 | 17.20 |
| C3 | 44.00 |
| C4 | 46.79 |
| C5 | 2.10 |
| C6 | 46.89 |
| C7 | 15.05 |
| C8 | 16.11 |
| — | — |
| E1 | 59.61 |
| E2 | 73.13 |
| E3 | 88.97 |
| E4 | 64.92 |
| E5 | 54.15 |
| E6 | 70.28 |
| E7 | |
| E8 | 90.28 |
| E9 | 89.11 |
| E10 | 80.76 |
| E11 | 73.23 |
| E12 | 91.93 |
| E13 | 67.99 |

As can be seen from the foregoing the compositions according to the invention provided excellent cleaning results, many of which were statistically superior to the compositions according to the comparative examples (C1-C8).

### Malodor Masking/Mitigation Evaluation:

Compositions according to the invention, specifically compositions according to E7, E8, and E10) were evaluated by a human subject. The compositions were observed to have a greatly mitigated malodor notwithstanding the presence of a significant amount of formic acid which is known to have a noxious odor. The human subject indicated a surprising mitigation of the trigeminal response.

While the invention is susceptible of various modifications and alternative forms, it is to be understood that specific embodiments thereof have been shown by way of example in the foregoing which are not intended to limit the invention to the particular forms disclosed; on the contrary the intention is to cover all modifications, equivalents and alternatives falling within the scope and spirit of the invention as expressed in the appended claims.

1. A highly aqueous liquid acidic hard surface cleaning composition having a pH of about 3 or less which comprises:
an acid constituent comprising sulfamic acid and at least one or more further co-acids;
at least one nonionic surfactant based on monobranched alkoxylated C10/C11-fatty alcohols;
an organic solvent constituent which comprises at least one glycol ether solvent;
optionally a cosurfactant constituent, including one or more nonionic, cationic, amphoteric or zwitterionic surfactants;
optionally one or more further constituents selected coloring agents, fragrances and fragrance solubilizers, viscosity modifying agents including one or more thickeners, pH adjusting agents and pH buffers including organic and inorganic salts, optical brighteners, opacifying agents, hydrotropes, abrasives, and preservatives, as well as other optional constituents known to the art;
and the balance, water, wherein water comprises at least 80% wt. of the composition.

2. A liquid hard surface cleaning composition according to claim 1 wherein the acid constituent comprises a further acid selected from one or more of: water soluble inorganic acids, mineral acids, or water soluble organic acids.

3. A liquid hard surface cleaning composition according to claim 2 wherein the acid constituent comprises formic acid.

4. A liquid hard surface cleaning composition according to claim 1 wherein the acid constituent comprises sulfamic acid, formic acid and at least one further co-acid, preferably citric acid.

5. A liquid hard surface cleaning composition according to claim 1 wherein the acid constituent consists solely of sulfamic acid and formic acid.

6. A liquid hard surface cleaning composition according to claim 1 wherein the organic solvent constituent comprises a glycol ether solvent.

7. A liquid hard surface cleaning composition according to claim 6 wherein the organic solvent constituent comprises propylene glycol n-propyl ether when the acid constituent comprises formic acid.

8. A liquid hard surface cleaning composition according to claim 1 wherein the said composition comprises a cosurfactant constituent selected from one or more nonionic, cationic, amphoteric or zwitterionic surfactants.

9. A liquid hard surface cleaning composition according to claim 1 wherein the said composition comprises a cosurfactant constituent selected from one or more nonionic surfactants, and wherein the cosurfactant constituent excludes cationic, amphoteric or zwitterionic surfactants.

10. A liquid hard surface cleaning composition according to claim 1 wherein the nonionic surfactant based on monobranched alkoxylated C10/C11-fatty alcohols is the sole surfactant constituent present in the compositions, to the exclusion of further nonionic, cationic, amphoteric or zwitterionic surfactants.

11. A highly aqueous liquid acid hard surface cleaning composition according to claim 1 wherein the composition has a pH of 0.1-2.

12. A highly aqueous liquid acid hard surface cleaning composition according to claim 11 wherein the composition has a pH of between 0.1 and 1.5.

13. A highly aqueous liquid acid hard surface cleaning composition according to claim 12 wherein the composition has a pH of between 0.25 and 1.

14. A highly aqueous liquid acidic hard surface cleaning composition according to claim 1, having a pH of about 2 or less, which comprises:
1-15% wt. of an acid constituent comprising sulfamic acid, but preferably necessarily comprising both sulfamic acid and formic acid, and optionally further comprising citric acid but excluding other inorganic or organic acids;
0.01-10% wt. of an organic solvent constituent which comprises at least one glycol ether solvent selected from the group: phenyl containing glycol ether solvents especially propylene glycol phenyl ether, propylene glycol n-propyl ether and dipropylene glycol n-butyl ether;
0.01-5% wt. of at least one nonionic surfactant based on monobranched alkoxylated C10/C11 -fatty alcohols;
0-5% wt. of a cosurfactant constituent, including one or more nonionic, cationic, amphoteric or zwitterionic surfactants and most desirably wherein the cosurfactant constituent consists solely of one or more nonionic surfactants;
0-5% wt. of one or more further constituents selected coloring agents, fragrances and fragrance solubilizers, viscosity modifying agents including one or more thickeners, pH adjusting agents and pH buffers including organic and inorganic salts, optical brighteners, opacifying agents, hydrotropes, abrasives, and preservatives, as well as other optional constituents known to the art;
and the balance to 100% wt., water, wherein water comprises at least 80% wt. of the composition.

15. A highly aqueous liquid acidic hard surface cleaning composition according to claim 14 wherein the organic solvent composition is solely propylene glycol n-propyl ether or is solely propylene glycol n-propyl ether with at least one phenyl containing glycol ether solvents.

16. A highly aqueous liquid acidic hard surface cleaning composition according to claim 15 wherein the at least one phenyl containing glycol ether solvent is propylene glycol phenyl ether.

17. A highly aqueous liquid acidic hard surface cleaning composition according to claim 1, wherein the organic solvent constituent excludes co-solvents.

18. A highly aqueous liquid acidic hard surface cleaning composition according to claim 14, wherein the organic solvent constituent excludes co-solvents.

19. A method for the treatment of stained hard surfaces in need of cleaning which comprises the step of applying a cleaning effective amount of the acidic hard surface cleaning composition according to claim 1 to a hard surface in need of a cleaning treatment.
